(19) United States
(12) Patent Application Publication
(10) Pub. No.: US 2011/0080134 A1
(43) Pub. Date: Apr. 7, 2011

(54) APPARATUS WITH ELECTRIC ELEMENT SOURCED BY A CAPACITIVE CERAMIC-BASED ELECTRICAL ENERGY STORAGE UNIT (EESU) WITH STORAGE CHARGING FROM ON-BOARD ELECTRICAL ENERGY GENERATION AND EXTERNAL INTERFACE

(76) Inventor: John Boyd Miller, (US)

(21) Appl. No.: 12/895,800

(22) Filed: Sep. 30, 2010

Related U.S. Application Data
(60) Provisional application No. 61/277,966, filed on Oct. 1, 2009.

(51) Int. Cl. H01M 10/46; H02J 7/00

(52) U.S. Cl. 320/101; 320/166

(57) ABSTRACT

Within an apparatus (20), a power storage unit comprising a capacitive ceramic-based electrical energy storage unit (EESU) (100) is capable of supplying electrical energy to an electrical energy using element (30) such as a light, a display, an electrical or electronic component or circuit, a motor, or an electro-mechanical component. The EESU (100) power storage unit in the apparatus is rechargeable and an EESU charging interface (110) is capable of charging the EESU (100) with electrical energy from either an external power interface (114) or one or more on-board electrical energy sources (140).

This Non-Provisional patent application Claims the Benefit of the Priority Date of Provisional Application No. 61/277,966 Filed Oct. 1, 2009.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to electrical energy storage, on-board electrical energy generation, external power interfacing, electrical energy storage charging, and energy usage within an apparatus, specifically, an apparatus contains an electrical-energy-using element (electric element), a power storage unit comprising a capacitive, ceramic-based electrical energy storage unit (EESU) capable of operating as a power source for the electric element, and a charging interface capable of charging the EESU with energy from one or more on-board electrical energy sources and from an external power interface.

2. Background of the Invention

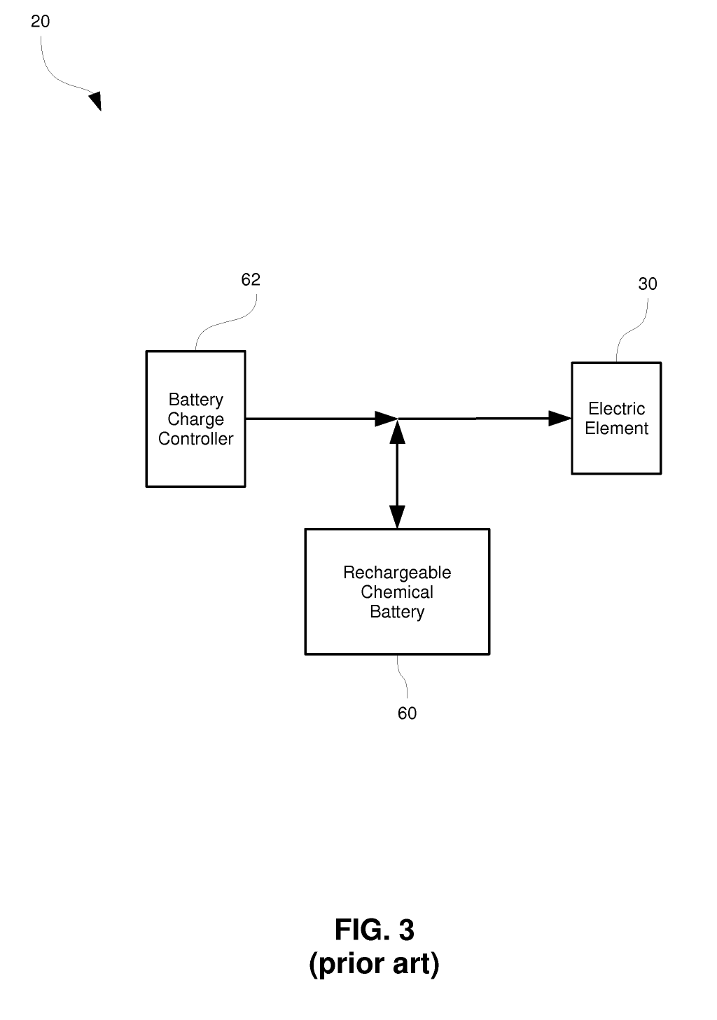

There are many devices currently with a rechargeable battery that have the option of either operating with power from the rechargeable battery or being powered by electricity from a wall outlet FIG. 3. With such devices, many times the rechargeable battery can be recharged by plugging the device into a standard wall outlet. In many such devices, such as in a camera, the user has the option of either recharging the battery in the device over time or simply replacing the battery with a charged battery so the device can be used while the depleted battery is charging in a separate charger.

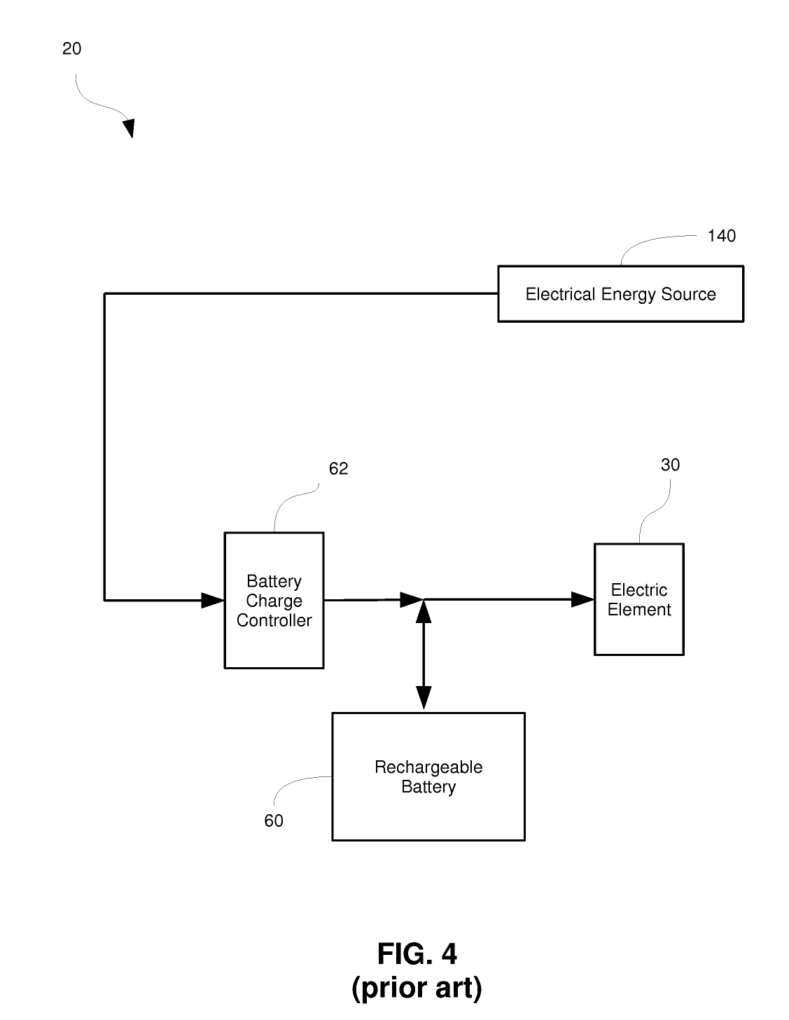

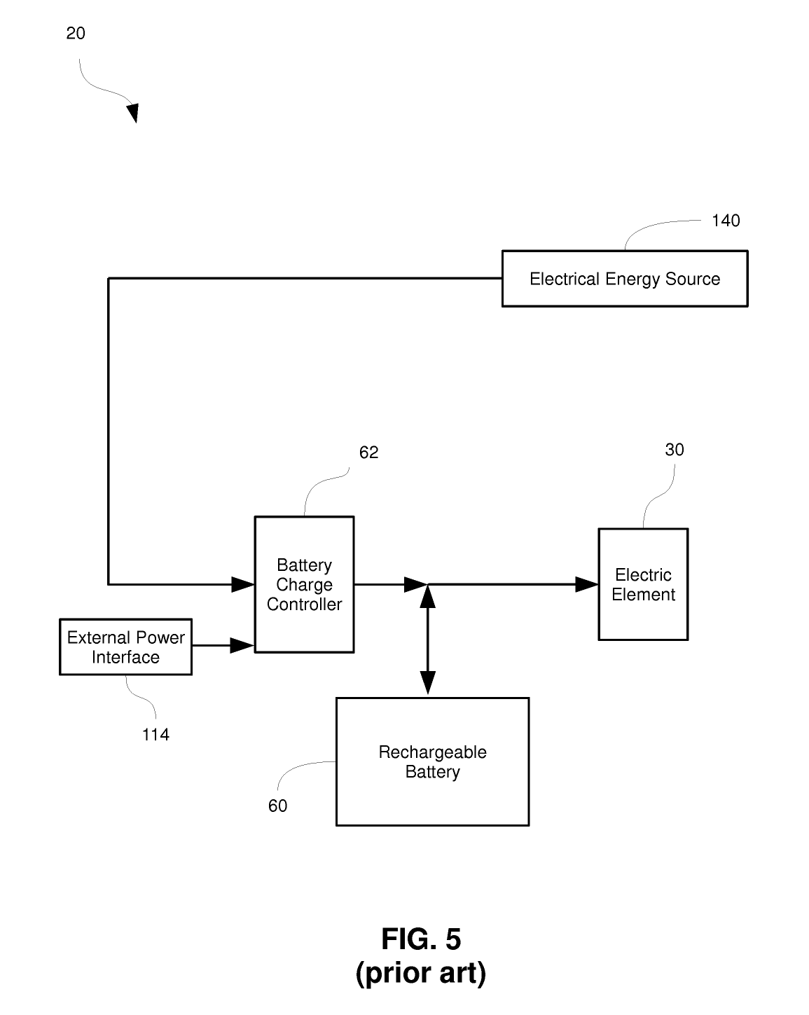

In other devices with a rechargeable battery, such as a calculator, the battery is recharged by an on-board electrical energy source such as a solar collector FIG. 4. And in yet other devices such as city crosswalk signs or neighborhood emergency warning systems, power for the device comes from a combination of utilizing city power from the electric grid most of the time, but should the local grid power go out, power to the device comes from a rechargeable battery that can be recharged from electrical energy from an on-board solar panel FIG. 5. In some cases this is a convenience, in others it goes beyond convenience to warn of hazards and therefore helps to create a safe environment.

Other examples of such devices include military equipment, golf carts, and electric automobiles with brake energy regeneration that allows energy to be stored back into the vehicle when braking occurs. Some electric automobiles even have solar collectors for on-board electrical energy generation.

Battery reliability is an issue in such devices that utilize a battery for electrical energy storage in that the rechargeable batteries in such devices, while potentially lasting for many recharge cycles, eventually get to a point where they can no longer hold a charge, they become marginally useful, and ultimately they must be replaced and disposed of. The number of deep-charge cycles a battery goes through, so-called memory issues, temperature issues, shelf life issues, and other battery issues limit the useful life of most, if not all, rechargeable batteries of any chemistry make-up to less than 10 years, and in many cases to only a few years. These battery life issues within backup and emergency devices create reliability issues that cause their backup or emergency availability to become questionable if not maintained and even replaced regularly. Battery life issues also severely limit or nullify the cost effective usefulness of batteries in many applications altogether because of maintenance and replacement cost issues for the user. When required, changing out batteries causes the user to incur costs in money as well as in time. As these rechargeable batteries are disposed of, they require time, effort and cost to recycle them, or if they are not recycled, they create waste and possibly pollution and toxic waste. Battery charge times are usually on the order of hours, requiring long wait times for users when charging becomes necessary. Full recharge times on the order of minutes are not available to the user.

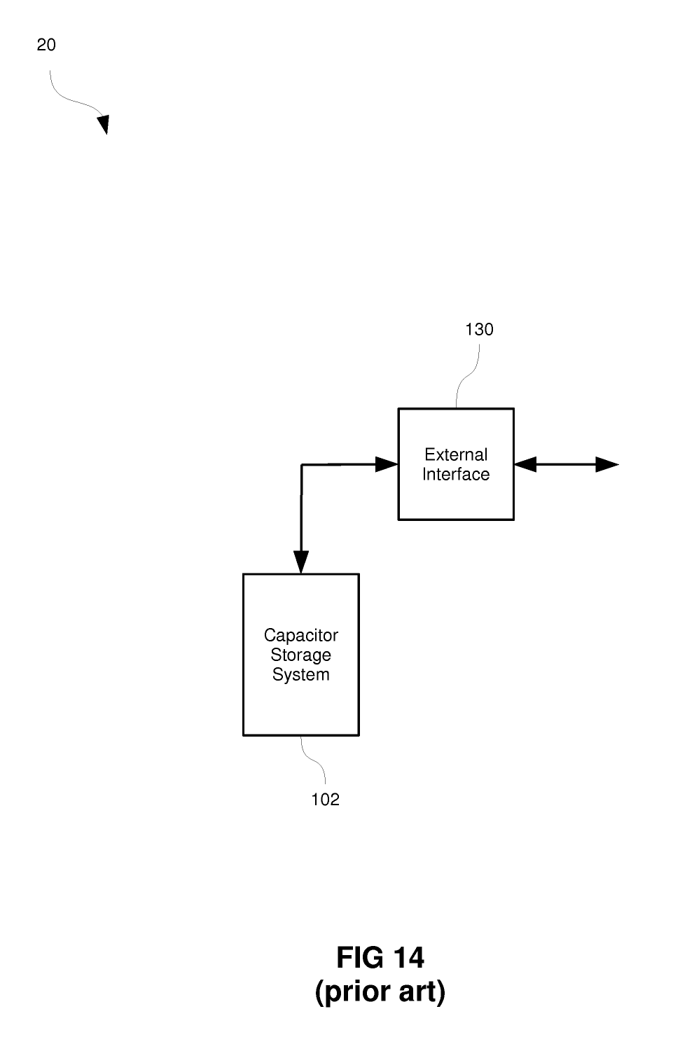

Generally fast charge and discharge capacitive based power storage devices are available FIG. 14 but their usefulness is usually in temporary storage applications. Examples of such uses are devices that are tied to the electric grid to store power for power outages or during off-peak hours, or those tied to a railway track to capture charge when a train brakes and to release charge quickly when the train starts up again. While capacitive power storage devices are generally reliable and allow hundreds of thousands of charge/discharge cycles with minimal degradation, their useable capacity tends to degrade in high temperatures, when stored for long periods, or when charged with excessive voltages. A high self-discharge rate that is much higher than batteries contributes to capacitor devices not being utilized in environments where long-term off-line power storage is needed. Also, current supercapacitors and ultracapacitors are capable of only low energy density storage which therefore gives the device the characteristic of being very large, very heavy, and generally non-portable for all but applications where very low power storage capacity is required.

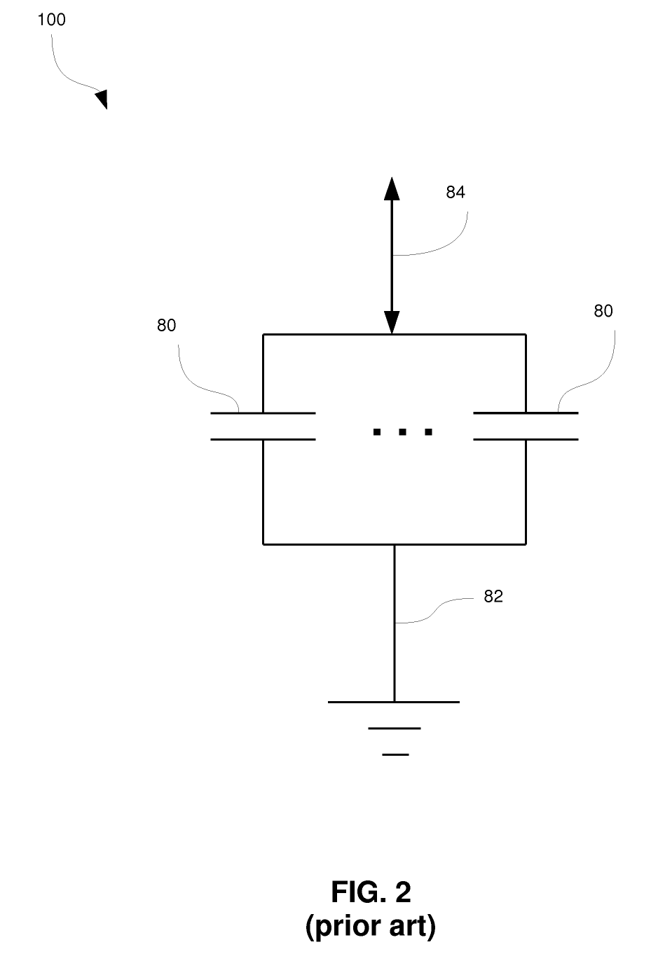

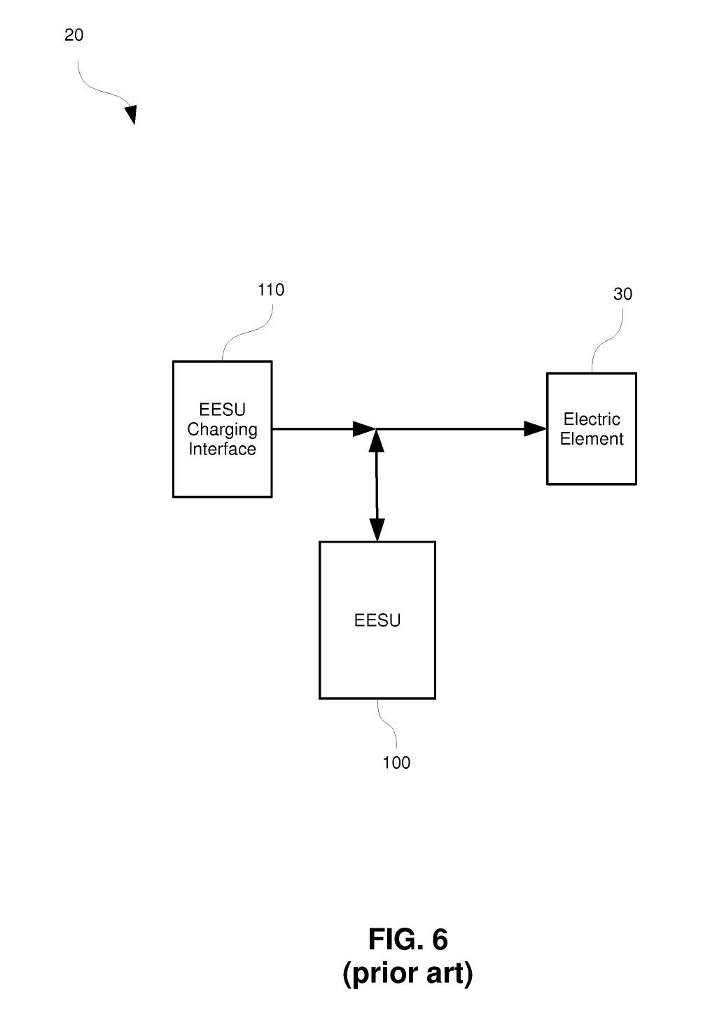

The prior art device of FIG. 6 utilizes a capacitive, ceramic-based electrical energy storage unit (EESU) FIG. 2 for energy storage. The FIG. 6 invention is described in U.S. patent application John B. Miller Ser. No. 12/873,317. The device of FIG. 6 operates similarly to the prior art device of FIG. 3 that utilizes a rechargeable battery in that the EESU can be charged from a source, although the source is not stated in this invention as to whether it is internal, external, or multiple sources. The use of an EESU in the FIG. 6 device eliminates most of the negative issues that batteries incur, as stated above.

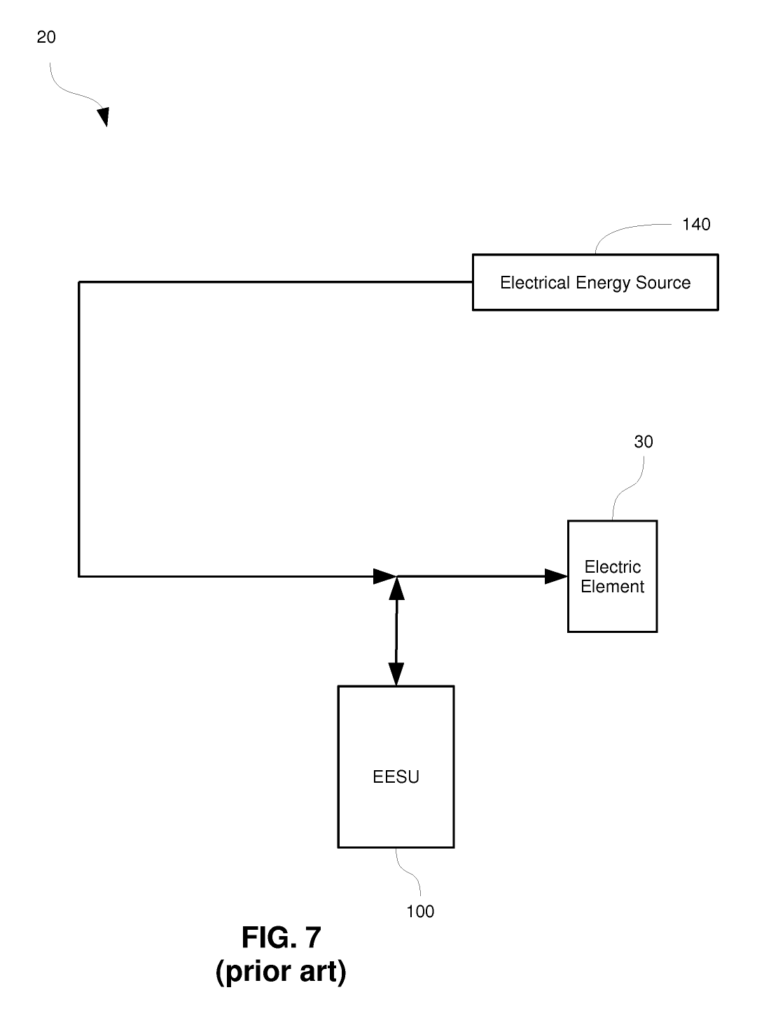

The prior art device of FIG. 7 is the invention of U.S. patent application John B. Miller Ser. No. 61/276,211. It also utilizes an EESU for electrical energy storage and operates similarly to the device of FIG. 4 that utilizes a rechargeable battery. Again, the multitude of battery issues as stated above are avoided in devices of the FIG. 7 invention due to the use of the EESU instead of a battery. The EESU of the FIG. 7 device is charged with an on-board electrical energy source such as a solar cell. Not allowing an external energy source to charge the EESU of the FIG. 7 invention is a restriction for the user when the user prefers fast charging or when on-board electrical energy availability is limited or unavailable altogether.

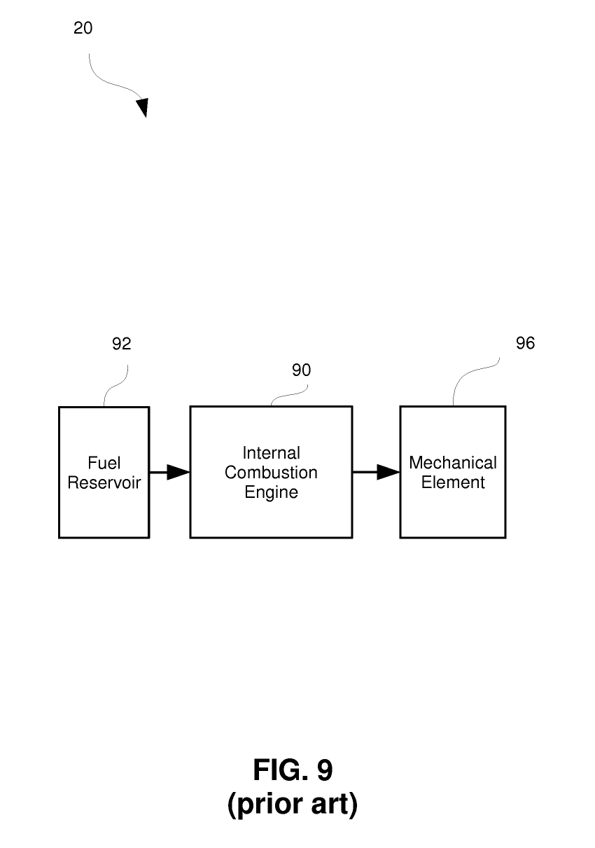

Many other devices utilize gasoline, diesel, propane, or natural gas powered internal combustion engines to provide portable and emergency utility FIG. 9. Examples of such devices are gas powered yard maintenance tools such as mowers, as well as portable road signs and portable lights with gas or diesel engines that generate electrical energy to power them. Still others include portable electric generators or backup generators that utilize an internal combustion engine to provide emergency power to homes, hospitals, businesses or other locations when another source of electric power is not available. Of course the most popular examples of portable devices that utilize internal combustion engine power are vehicles, watercraft, and aircraft.

For devices that utilize internal combustion engines, the advantages are quite apparent in that with a little combustible fuel, the devices can provide a useful amount of work. The disadvantages to utilizing this type of power for an apparatus include the requirements of handling, storage, and delivery of dangerous, toxic and explosive fuels. Another disadvantage of this type of power generation is that these engines require regular maintenance to perform properly. Maintenance of these engines also requires the use, storage, and handling of somewhat messy lubrication oils. Another disadvantage is that the overall conversion efficiency of energy for useful work using an internal combustion engine is low. Even when an apparatus is idling and performing no useful work, energy is being expended. Engine exhaust is also a contributor to pollution. Few if any devices with an internal combustion engine can supplement or replenish the energy utilized by their engines with on-board energy generation methods as can devices based on batteries that include on-board energy generation capabilities such as solar power generation via solar cells FIGS. 4 and 5.

3. Objects and Advantages

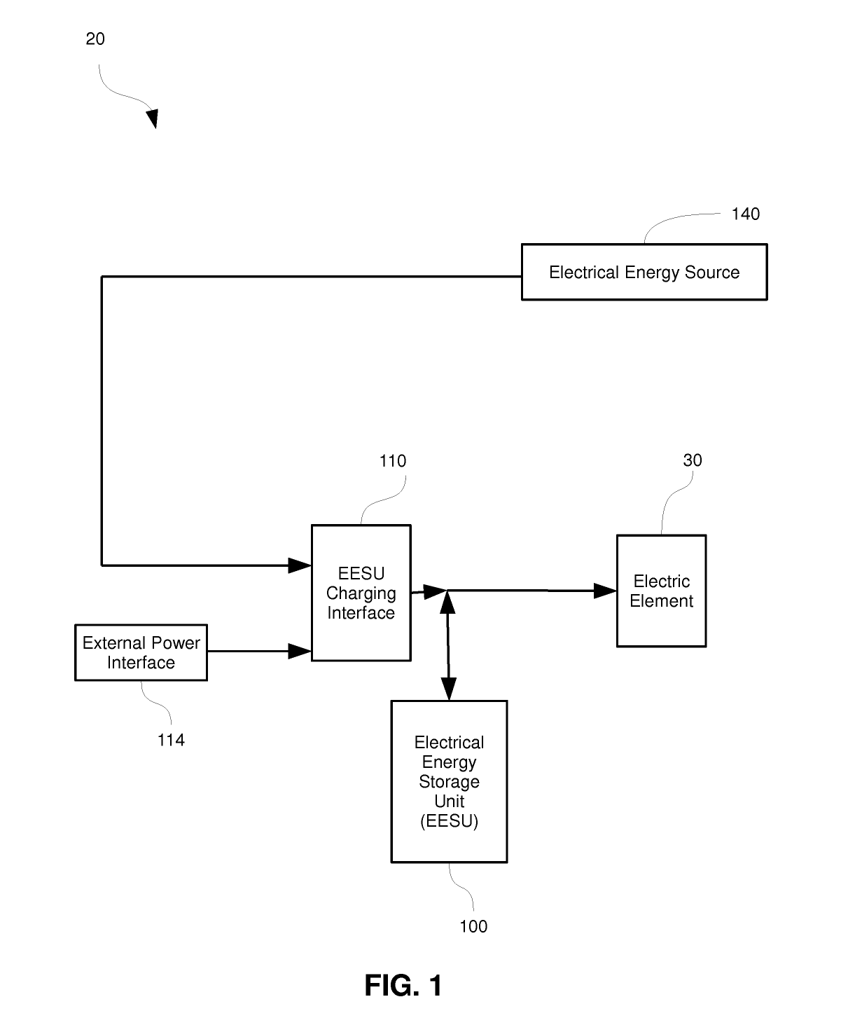

Accordingly, a solution to these issues is an apparatus FIG. 1 that includes an electrical-energy-using element (electric element) such as a light, a display, an electrical or electronic component or circuit, a motor, or an electro-mechanical component, that is powered from a power storage unit comprising a capacitive, ceramic-based electrical energy storage unit (EESU) FIG. 2 that is capable of storing large amounts of energy in a dense area, that is capable of accepting large charge currents without intermediate capacitors thereby allowing quick recharging with minimal system costs, that does not show significant degradation over time, temperature, voltage, or with charge cycles, that does not show significant shelf-life issues, that has minimal impact on the environment when disposed of, that includes a built-in charging circuit designed specifically for a highly capacitive load and high voltages, and that includes one or more on-board electrical energy generation sources as well as an external power interface to supply electrical energy to drive the electric element and to charge the EESU power storage unit.

A device of this invention includes multiple sources from which to supply electrical energy to drive the electric element and to charge the EESU power storage unit. As shown in FIG. 1, this includes an on-board electrical energy source such as a solar collector or a wind turbine, as well as an external power interface such as one capable of connecting to a standard wall outlet or other external power source. This is similar to the prior art device of FIG. 5 that stores electrical energy in a rechargeable battery, but since the device of this invention is based on an EESU instead of a battery, a user of a device of this invention is freed from a multitude of battery related issues.

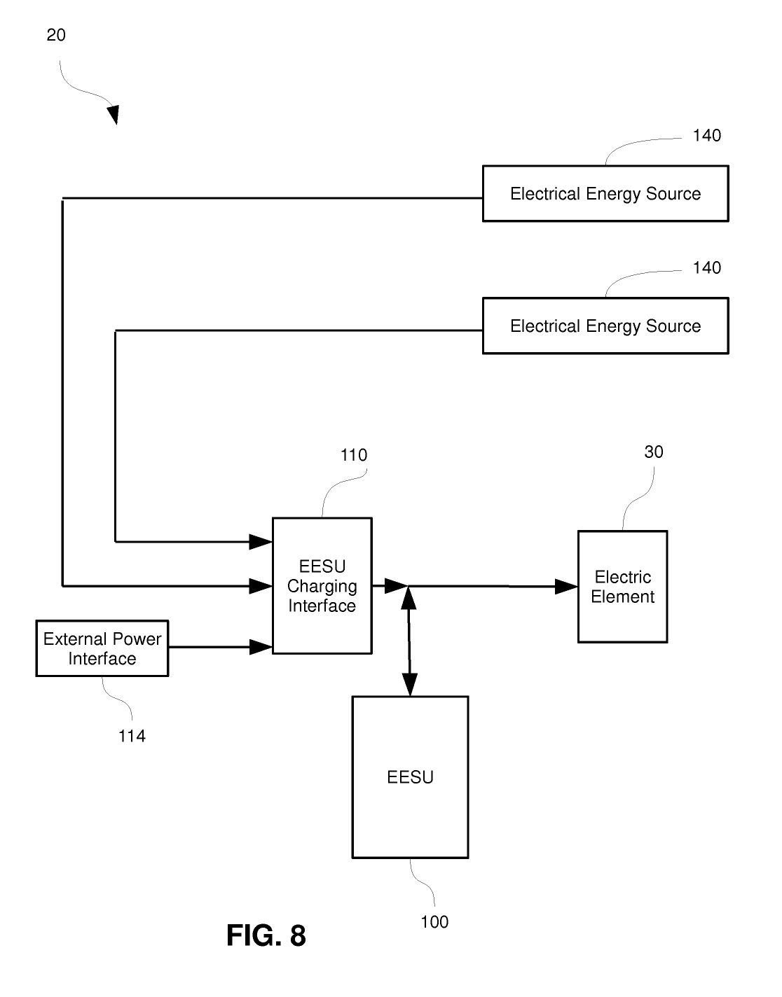

To increase the usage of renewable resources, FIG. 8 also shows a device of this invention and is similar to FIG. 1 but includes multiple on-board electrical energy sources. This allows the user to utilize as many on-board electrical energy generating sources as are available to maximize renewable energy usage while still allowing the device to connect to the electric grid or some other external power source to power the electric element or to charge the EESU power source quickly when necessary. To increase the usage of renewable resources even further, the external power interface can be designed to connect to other devices with on-board energy generation such as devices based on patent application John B. Miller Ser. No. 61/277,466 that utilize one or more on-board electrical energy sources to store electrical energy into an EESU power storage unit for use external to the device. Utilizing external as well as on-board renewable energy sources in a device of this invention multiplies the effectiveness of the device to minimize energy usage from the electric grid which minimizes dependence on oil products and other natural resources, minimizes pollution that comes with their usage, and minimizes costs related to the use of these resources for the user.

One element of an apparatus of this invention FIG. 1 is on-board electrical power generation. Electrical power generation on devices of this invention can come from a variety of sources including solar collectors, wind turbines, electro-mechanical systems such as motor feedback, man-powered systems such as exercise equipment built for generating electrical power, thermal, acoustic, and static generators, water-powered or rain-powered generators, as well as electric generation powered by an internal combustion engine or from nuclear energy, as well as others.

Another element of an apparatus of this invention is the EESU charging interface. An example of a charging circuit designed to handle the specific charging needs of an EESU is a circuit based around the LTC3751 high voltage capacitor charge controller integrated circuit from Linear Technology Inc. Specific circuitry within an EESU charging interface is determined by the voltages used in the apparatus and the manufacturer's preferred charge time requirements and cost goals for a particular apparatus. In particular, a high powered charger can be designed into an apparatus to accept charge quickly and to charge the device in minutes, or a lower powered charger can be designed into the apparatus to allow charging more slowly and possibly with less expense. This is unlike most battery charge controllers which utilize a somewhat generic chemistry changing charge algorithm specifically designed for the chemistry of a particular battery that can charge at a slow measured pace of over an hour or more. Most, if not all, batteries do not have the capability to fully charge in minutes. Also, unlike battery chargers, a charger in an apparatus of this invention is designed to charge a highly capacitive load at high voltages and need not be sensitive to overcharging, overvoltage, or charging the EESU faster than a particular chemistry can handle it as with batteries. The EESU charging interface can also be designed to drive the electric element directly.

Yet another element of an apparatus of this invention, the external power interface, can have varied functionality and can take various physical forms. For example, in some devices the external power interface will connect to a standard low voltage AC wall plug. In others, the interface can be designed to connect to a higher voltage AC source, possibly with multiple phases, or it can connect to a DC voltage source or other sources. The physical form of the external power interface can be such that it is built with electronics such as semiconductor power MOSFETs and voltage and current control circuitry, or it can be as simple as an electro-mechanical switch or even a simple mechanical interface.

The other key element of an apparatus of this invention is a rechargeable, high density, capacitive, ceramic-based electrical energy storage unit (EESU) FIG. 2. An example of such a unit is the Electrical Energy Storage Unit (EESU) of Richard Dean Weir, U.S. Pat. No. 7,466,536 B1. The preferred embodiment of this referenced patent shows that integrated circuit techniques are utilized to sinter extremely high permittivity Barium Titanate crystals into a bulk ceramic substrate giving a very high-density capacitive energy storage capability. The referenced patent discusses a complete ceramic based EESU with 31,351 capacitive elements connected in parallel giving a total storage capacity of 52 kilowatt-hours (kWh) at a weight of 286 pounds. As the referenced patent states, this is enough electrical energy to power a vehicle for 300 miles. Other qualities are that the EESU of the Richard Dean Weir patent can be charged in about five minutes, self-discharges slower than batteries and therefore has a long shelf-life and is useful for long-term storage, and it is non-explosive, non-toxic, and non-hazardous. According to TABLE 1 of the referenced patent, this EESU gives over twice the energy density of Lithium Ion (LiIon) batteries and over five times the energy density of NiMH or any other high-density chemistry-based batteries.

The above referenced patent for an EESU covers one element of the current invention, an apparatus that is in and of itself a high density, capacitive, ceramic-based electrical energy storage unit. Versions of this EESU storage system, or other similar ceramic-based electrical energy storage units, can be made into various sizes, energy capacities and operating voltages to power any sized device. By combining an EESU of appropriate size, energy capacity, and voltage to deliver energy to an electric element such as a light, a display, an electrical or electronic system, a motor, or an electro-mechanical system, and by adding on-board energy generation and recharge circuitry specifically designed to charge the EESU, an apparatus of this invention is created. Many useful and reliable portable and non-portable devices of this invention can be created, including the exemplary battery-based devices as mentioned above, as well as electrical equivalents to the internal combustion engine based devices also mentioned above.

Advantages of devices of the current invention over prior art electro-chemical battery based devices include that an apparatus of the current invention will give the user a nearly unlimited lifetime of usefulness without the power storage unit requiring replacement. This is due to the energy generating capability, the recharge electronics, and the EESU power source within the device allowing a nearly unlimited number of recharge cycles with little degradation due to the number of recharge cycles, the number of deep charging cycles, extreme temperatures, or extreme voltages. On the other hand, batteries in battery-based devices degrade with usage and can be recharged only a limited number of times before their energy storing capabilities degrade to the point that the batteries need to be replaced.

As an example, LiIon batteries as are used in electric vehicles can be cycled up to about 1200 times before needing replacement. Almost all other popular battery chemistries can be cycled fewer times than this before replacement is required. Deep cycling LiIon or other batteries or using them in extreme temperatures will further limit their charge holding capabilities and can require them to be changed out sooner. The longevity of these batteries can be of great interest to an owner of an electric vehicle since replacement of such a large number of batteries can be very costly to the owner, possibly a significant percentage of the original cost of the vehicle. Similarly, owners of hybrid vehicles face battery replacement expenses after a number of years, although since these vehicles also have an internal combustion engine, deep cycling can be minimized and their usage can be extended. While battery life longevity in a vehicle will differ with battery type and with usage, nearly all experts agree that battery charge holding capabilities will degrade over time and that at some point the batteries will need to be replaced. Many times when batteries need to be replaced, an entire device is discarded due to the cost and effort to replace the battery. By utilizing the current invention, users are free to use their device without the concern of periodically changing out a portion of their device and can therefore minimize the waste and possibly the toxic waste associated with the disposal of batteries, can minimize or eliminate the need to utilize energy to recycle batteries, and can realize significant cost and time savings by not having to change out, dispose of, or recycle batteries.

Charging an apparatus of this invention is accomplished by delivering electrical energy from the external power interface or from one or more on-board electrical energy-generating devices to the EESU through the EESU charging interface. For convenience, some devices can include the option of changing out the EESU, as with prior art battery powered tools, for the purpose of quickly changing out a discharged EESU for a fully charged EESU. A major advantage an apparatus of this invention has over an apparatus that utilizes electro-chemical batteries is that during charge cycles, the EESU of this invention requires only that charge be transferred and does not require the slow process of a chemistry change and the required measured timing and overcharge safety precautions for such a process as electro-chemical batteries require. Charge times in an apparatus of this invention with an EESU can therefore be dramatically faster than in an apparatus with a battery since full charging of large capacity EESUs can occur in only minutes as opposed to over an hour in even the fastest battery based systems. This feature alone opens the possibility for such an apparatus to be utilized for many useful and cost effective purposes where batteries would see limited use if any.

Size and weight are another advantage for an apparatus of the current invention. This is because the energy density of the EESU power storage unit in the current invention is greater than that of popular electro-chemical batteries. Thus a device of this invention with an EESU can give the user more energy storage capacity than a prior art device with a battery of comparable size and weight, again opening up many useful applications for an apparatus of this invention.

Reliability is a key advantage for a device of this invention when compared to a device based on a battery. Far more reliable and therefore more cost effective devices can be built around an EESU power storage unit due to the reliability of the EESU itself. This opens up a large number of potential new uses. An example is a remote power generator with a solar collector that utilizes an EESU to store power instead of a battery. Utilizing batteries in a situation such as this may be unsuitable due to extreme temperatures, limited shelf life, and so called battery chemistry memory issues that over time can significantly diminish the amount of electric charge available for use when needed. For batteries, these issues all bring maintenance and cost issues, but more importantly they bring reliability issues that can cause the device to fail just when it is needed most. This can have the effect of rendering useless all the efforts and costs employed by a user to ensure the reliable usage of a valuable system when main power to the system goes out. Devices of this invention, however, will incur none of these negative issues and will be capable of performing without incident over extended periods of time and in harsh environments. Utilizing solar, wind, or other on-board energy generation methods will allow devices of this invention to operate reliably for extended periods without significant performance degradation over time as with battery based devices.

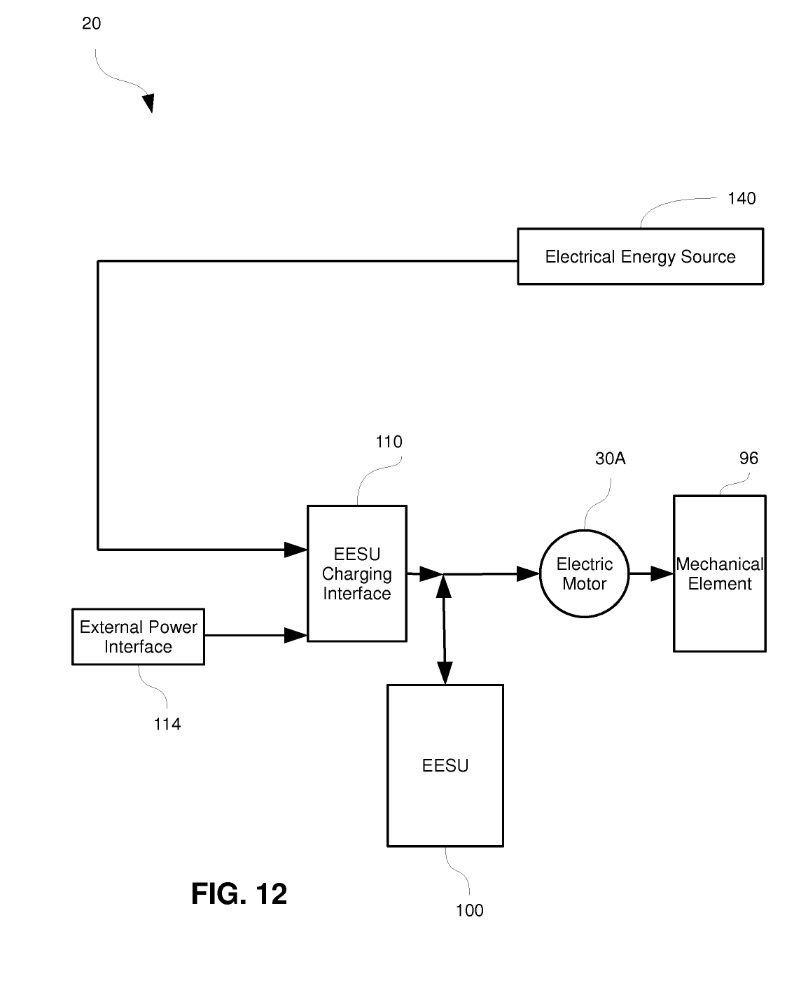

Yet another advantage of this invention is that it will power relatively clean electric motors FIG. 12 to replace internal combustion engines FIG. 9 in many devices. These clean electric motors will not require the mess of handling fuels and large quantities of oils as with internal combustion engines. Nor will the constant maintenance of internal combustion engines be required. Even energy availability will be less of an issue with this invention since energy recharge is accomplished by recharging with on-board energy generation or by connecting anywhere to the currently available electric grid. No longer will the major overheads of time, effort, and cost be required to deliver fuel to thousands of filling stations to make it available to users, and no longer will users be required to travel miles to a filling station to get fuel, and then to store potentially dangerous and messy fuels at their homes or work locations as with fuel for current yard maintenance equipment. Utilizing this invention in devices instead of gas or diesel engines will also eliminate the exhaust of millions of internal combustion engines thereby reducing pollution and heat that could be factors in global warming. Less noise will also be a result of a user utilizing a device with an electric motor instead of an internal combustion engine.

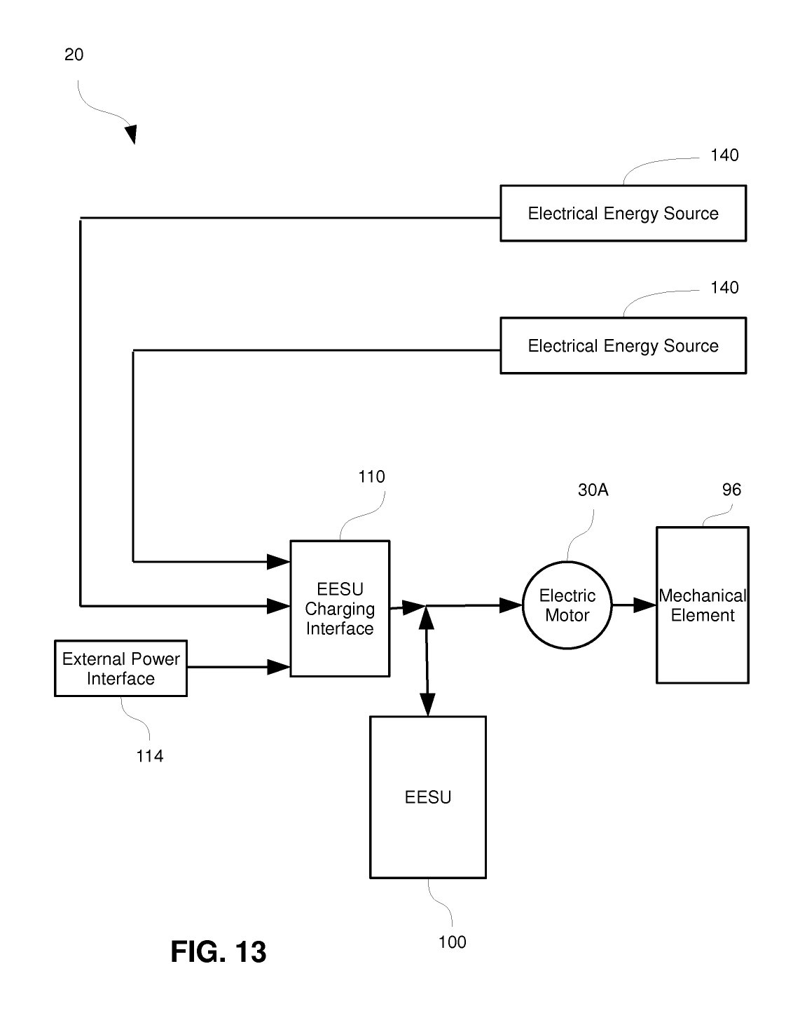

Prior art devices that utilize an internal combustion engine as their sole power source contain no capability for on-board energy generation. Utilizing this invention to create, for example, a vehicle or a roadway sign with on-board energy generation such as solar energy generation creates a device with unique reliability that is capable of charging itself while not in use, as well as being able to charge itself while in use, to extend its operating time before a full recharge is necessary. In current vehicles utilizing gasoline or diesel internal combustion engines as their sole energy source, the vehicles must stop at a filling station for all fuel, or fuel must be brought to them. For roadway signs, generally all fuel is delivered to the roadway sign, or all fuel is brought with the roadway sign to its destination. In either of these examples, there is no opportunity for gas or diesel fuel to be generated on the vehicle or on the roadway sign. This is the case for nearly all devices utilizing internal combustion engines as their sole energy sources. The exception is with hybrid vehicles that utilize batteries for their main electrical power storage that can collect energy that is generated on-board. Hybrid vehicles, though, also contain many of the shortfalls of battery based devices as described above. Creating a device of this invention FIGS. 12 and 13 such as a vehicle, that includes an EESU for energy storage, an electric motor as its electric element to drive the wheels, and an external power interface as well as on-board energy generation to recharge the EESU through a charging interface, creates a versatile and reliable device with both fast external charge capability as well as convenient and planet-friendly on-board energy generation that is truly useful and unique.

Supercapacitors or ultracapacitors are utilized in many places, primarily for temporary power storage and for power conditioning, however their usefulness in prior art devices as sole energy storage elements FIG. 14 has been limited. This is due to poor long-term power storage capabilities caused by a self-discharge rate that is higher than that for batteries, and in particular it is due to their limited energy density as compared to batteries and the large overall apparatus size and weight that is realized when these capacitors and ultracapacitors are utilized for primary power storage.

While the best ultracapacitors demonstrate energy density of 6 to 60 Wh/kg, with typical commercially available power capacities being closer to 6 Wh/kg, the EESU power source of the above referenced Richard Dean Weir patent is rated at an energy density of 400 Wh/kg giving it over 6 to 60 times the energy density or about ⅙^{th} to 1/60^{th} the size and weight for a given storage capacity. For comparison, Lithium Ion (LiIon) batteries generally have energy densities from 150 to 200 Wh/kg, roughly 3 to 30 times that of ultracapacitors.

As an example, for a 2000 pound vehicle to travel 300 miles, approximately 52 kilowatt-hours (kWh) of energy will be required (as shown in the above referenced Richard Dean Weir patent). A vehicle can travel this distance utilizing a 286 pound EESU power source that is capable of storing 52 kWh of energy. Equivalently, to travel this distance it would take a vehicle capable of handling the size and weight of ultracapacitors weighing from over 1,000 pounds to over 10,000 pounds just for the ultracapacitor power storage, with generally available ultracapacitors weighing closer to 10,000 pounds. Conversely, putting just 286 pounds of generally available ultracapacitors with 6 Wh/kg per unit, or about 1400 Wh of electrical energy, into a small vehicle would give users an average traveling distance of approximately 8 miles, limiting the usefulness of a common vehicle. Again, continuing the comparison, 286 pounds of LiIon batteries at 160 Wh/kg would give nearly 125 miles of travel distance.

As can be seen by one skilled in the art, utilizing ultracapacitors for primary power storage could change vehicles as we know them today. This could very well change their usefulness to users. Their usability for many applications might come into question. Instead of giving devices features that include the greater conveniences to the user of being smaller, lighter weight, easier to handle, and more portable, the character of such devices could change dramatically to being larger, heavier, more awkward to handle, and less portable, if their character and usefulness could then be classified as portable at all. The nature and usability of some devices could be changed completely. For example, while utilizing a 1000 to 10,000 pound primary electrical power storage unit made with prior art ultracapacitors in an electric vehicle may allow it to continue to operate, possibly in a limited fashion, adding this kind of weight for power storage to a small aircraft powered by electric motors instead of an internal combustion engine can make the aircraft so heavy that it cannot lift off the ground or fly, clearly making a power unit utilizing prior art ultracapacitors unusable in such aircraft. Conversely, a power unit of the current invention with a high electrical energy storage capacity and weighing only a few hundred pounds will be very useful in such an aircraft and can easily allow a significant flying range. A similar case can be made for small watercraft where utilizing a 1000 to 10000 pound primary electrical power storage unit in such a craft could sink the craft, clearly changing the usefulness of the craft to the user.

Also, while an ultracapacitor can experience a loss of power storing and usage capabilities during extreme conditions such as charging and discharging at high temperatures, excessive charging voltages, or even when a power unit sits unused for long periods of time such as might occur in military and emergency uses, an EESU of the above referenced Richard Dean Weir patent does not degrade with temperatures or overvoltages with even the highest generally available voltages (less than 5×10̂6 Volts).

As can be seen above, devices of the current invention have operational features and capabilities that are markedly different from prior art devices powered by batteries, by internal combustion engines, or by capacitors and ultracapacitors.

Table 1 below shows that while most batteries of various chemistry make-ups show mostly similar traits, an apparatus of this invention shows capabilities of being able to operate in different environments, with different limitations, and with different features, than a battery based apparatus that performs a similar function.

Similarly, Table 2 show that a device of this invention offers significant operational differences and features from a device powered by an internal combustion engine that performs a similar function.

And in Table 3, a device of this invention can clearly be seen as useful in portable devices since the energy density of the EESU power source within the device is far smaller than for equivalent ultracapacitor power sources for devices, and is even twice that of popular LiIon batteries, therefore giving the potential for an even smaller power source and an even smaller overall apparatus size than is generally available today, thereby giving the user even more portability and convenience. On the other hand, a similar device utilizing prior art ultracapacitors as a power source would be of such a size and weight that its use as a portable device would be limited and could possibly be seen as changing the device from a portable device to a non-portable device, thereby changing the nature and usefulness of the device for the user completely. Similarly, long term power storage is not an issue in an apparatus of this invention, while high leakage currents and potential memory effects can affect long term power storage capabilities in a similar device utilizing ultracapacitors.

TABLE 1
Operational And Functional Feature Differences:
Prior Art Battery Powered Apparatus vs. Current Invention Apparatus

| A Prior Art Apparatus With Electro- | An Apparatus Of This Invention |
|---|---|
| Chemical Battery Power Source | With An EESU Power Source |
| Expect Unreliable Apparatus Performance | Expect The Same Reliable Apparatus |
| After A Period Of Time | Performance Indefinitely |
| Due to Battery Chemistry Degradation | No Chemistry To Degrade In EESU |
| Due to Battery Memory Effect | Minimal Memory Effect In EESU |
| Due to Battery Deep Cycling | No Issues Due To Deep Cycling In EESU |
| Expect To Change Out Apparatus Battery After | No Need To Change Out EESU In Apparatus |
| A Period Of Time Due To Normal Wear | Because Of Normal Wear |
| Time And Effort Inconvenience For User | No Inconvenience To User |
| Cost For User | No Cost To User |
| Device Itself Becomes Unusable If | Apparatus Generally Only Becomes |
| Replacement Battery Not Found Or Is | Unusable With Mechanical Element |
| Not Cost Effective | Wear Or Breakage |
| If Apparatus Utilizes Recyclable Battery, | Apparatus Will Generally Not Degrade To The |
| Expect To Require Time, Effort, And Cost To | Point Of Requiring EESU Replacement. |
| Recycle Battery After A Period Of Time, or | EESU Could Possibly Be Used Or Sold As |
| Expect To Pollute The Environment If Battery | Useful Power Storage Device |
| Is Discarded | Even After The Rest Of The Apparatus |
| | Is Discarded Or Replaced |
| After Apparatus Battery Is Discharged, | After Apparatus EESU Is Discharged, |
| Apparatus Is Unusable Until Battery Is | Apparatus Is Unusable Until EESU Is |
| Charged Or Changed Out | Charged Or Changed Out |
| Battery Requires Electro-Chemical | EESU Needs Only To Transfer Charge, |
| Transfer, Charges Slowly At A Measured | Charging Can Take Place In Minutes |
| Pace Over an Hour To Charge Fully | Fast Charge To Full Charge In EESU |
| Fast Charge To Full Charge Is Generally | Is Standard Practice |
| Not Possible With Batteries | Replacement EESU Is Not Required If |
| Replacement Battery Is Generally Used | User Can Wait Minutes For Recharge |
| While Primary Battery Is Charging | (Possibly Less Than A Minute In Small |
| Second, Third, Or Even Fourth | EESUs) |
| Replacement Battery Sometimes | Second EESU Can Be Used When No Wait |
| Required During Primary Battery Charge | Time Is Preferred By User |
| Period | |
| Extreme Temperatures Limit Usefulness And | Extreme Temperatures Do Not Limit |
| Reliability Of Apparatus With Battery Due To | Usefulness Of Apparatus Due To EESU. |
| Battery Chemistry Issues | |

TABLE 2
Operational And Functional Feature Differences:
Prior Art Internal Combustion Engine Powered Apparatus vs.
Current Invention Apparatus

| Prior Art Apparatus | Apparatus Of This Invention |
|---|---|
| With Fuel Engine Power Source | With EESU Power Source |
| Apparatus Takes Only Minutes To Refuel | Apparatus Takes Only Minutes To Recharge |
| Apparatus Is Usually Noisy Due To | Apparatus Is Usually Quiet Due To |
| Engine Noise | Electric Motor Being Relatively Quiet |
| Muffler Always Required | No Muffler Required |
| Apparatus Requires User Deal With Fuels | Apparatus Is Clean And Requires User To |
| That Are Explosive, Toxic, And Messy | Power Device Somewhat Like Many Current |
| | Home Appliances And Tools |
| To Fuel Apparatus, Travel To A Gas Station | Charging Apparatus Can Be Done Anywhere |
| Required | From The Current Electric Grid Or From On- |
| | Board Electrical Energy Generating Sources |
| Fuels To Refuel Apparatus Must Be | Energy To Recharge Apparatus Is Available |
| Transported Via Trucks To Gas Stations | Everywhere The Electric Grid Is Available |
| Requires Transport Time, | Electricity Delivery Costs And |
| Transport Cost, And | Maintenance Is Shared With Current |
| Pollution From Delivery Trucks | Electric Grid Users |
| Extra Fuel Can Travel With Apparatus To | Extra Replaceable EESU Power Modules Can |
| Refuel Anywhere | Travel With Apparatus To Replace |
| | Discharged Modules Anywhere |
| Apparatus Emits Exhaust Emissions | Apparatus Emits No Exhaust Emissions, |
| | Not Even Vent Gasses |
| Engines In Apparatus Require Periodic | Apparatus Motor Requires Little Maintenance, |
| Tune Up And Maintenance | Similar To High Use Air Conditioning |
| | Condenser Or Fan Motors |
| Apparatus Complicated By | Apparatus Similar To |
| Complex Mechanical Engine | Simple Electric Appliance |
| Apparatus Utilizes Fuel Energy Inefficiently | Apparatus Energy Utilization Is More Efficient |
| Internal Combustion Engine Overall | Than For Internal Combustion Engine |
| Efficiency At Converting Energy To | Apparatus |
| Useful Work Is Low | Even After Electricity Generation, A |
| Fuel Engines Utilize Energy Even At Idle | Vehicle With An Electric Motor Is Nearly |
| Times When No Useful Work Is Done | Twice As Efficient As A Vehicle With An |
| | Internal Combustion Engine |
| | Energy Usage Can Be Stopped During |
| | Idle Periods To Conserve Energy |

TABLE 3
Operational And Functional Feature Differences:
Prior Art UltraCapacitor Powered Apparatus vs. Current Invention Apparatus

| A Prior Art Electric Energy Generation & | Electric Energy Generation & Storage |
|---|---|
| Storage Apparatus With UltraCapacitor | Apparatus Of This Invention |
| Power Storage | With EESU Power Storage |
| Apparatus capable of 10 year life with little | Apparatus capable of greater than 10 year life |
| power storage unit degradation unless used in | regardless of extreme temperatures or voltages. |
| extreme temperatures, voltages or storage | |
| situations. | |
| Size and Weight, due to limited energy density, | Size and Weight, due to high energy density, |
| restricts apparatus from being portable in all but | allows smallest and lightest apparatus |
| extreme applications. | compared to any capacitor or popular electro- |
| | chemical battery based apparatus, inviting use |
| | in all portable devices and applications. |
| Long-Term Power Storage Is Limited Due To | Long-Term Power Storage Is Not Limited Since |
| High Self-Discharge Rate and Memory Effects. | Self-Discharge Rate Is Very Low And Memory |
| | Effects Are Minimal. |

Through the comparisons shown in Tables 1, 2 and 3, it can be seen that an apparatus of this invention has distinctively different operational capabilities and features than either a prior art battery based apparatus, a prior art apparatus with an internal combustion engine, or a prior art capacitor or ultracapacitor based apparatus. Even hybrid vehicles with gasoline engines, batteries, and capacitors are not only different, but include many of the differences of each prior art apparatus, a battery based apparatus, an engine based apparatus, and a capacitor based apparatus, each with their own clear differences.

There are also differences in the built-in charging circuits of an apparatus of the current invention verses a prior art apparatus utilizing a battery as an energy storage source. While an EESU charging circuit can be designed to charge an EESU to a full charge within minutes or over a longer period of time, a prior art battery charger can only charge to a full charge at a slower speed, generally over an hour. And while an EESU charging circuit can charge utilizing general voltage and charge current targets, a prior art battery charger must utilize charging algorithms to provide varying voltages and currents at different stages of the charging process to suit the particular chemistry make-up of the battery, and they must closely monitor conditions that could lead to overvoltage, overcurrent, and overheating. Even prior art capacitor and ultracapacitor charging circuits must use caution to avoid allowing overvoltage lest the charge carrying capabilities and the charge releasing capabilities of the capacitor be degraded. The EESU, as described in the above referenced patent, does not exhibit these limitations for even the highest of generally available voltages.

As can readily be seen, an apparatus of the current invention utilizing as its power source an EESU such as that in the above referenced patent, or a similar ceramic based energy storage device with similar qualities, has a significant advantage over an apparatus designed for a similar use that utilizes a prior art electro-chemical battery as a power source. Therefore it can be easily seen by one skilled in the art that an apparatus of this invention is clearly not just another battery based device with a new type of battery that includes many of the prior art electro-chemical battery's features and limitations.

Likewise, since an apparatus of the current invention utilizing an EESU as its power source is capable of long-term power storage due to very low leakage current and has the advantage of allowing nearly any device to have a smaller size and weight than current prior art devices, thus allowing many of them to be portable, an apparatus of this invention clearly has different features and operational capabilities than prior art devices utilizing capacitors or ultracapacitors as their power source.

Other objects of this invention and advantages of this invention will become apparent from a consideration of the ensuing description and drawings.

### SUMMARY

In accordance with the present invention, an apparatus includes an electrical-energy-using element (electric element) such as a light, an electrical or electronic component or circuit, a motor, or an electromechanical device, and a power storage unit comprising a capacitive, ceramic-based electrical energy storage unit (EESU) capable of supplying electrical energy to the electric element, an interface for charging the EESU, and on-board electrical energy generation and an external power interface each capable of supplying electrical energy to charge the EESU or to drive the electric element directly.

### DRAWINGS

### Figures

The following description includes discussion of figures having illustrations given by way of example of implementations of embodiments of the invention. The drawings should be understood by way of example, and not by way of limitation.

FIG. 1 shows an apparatus with an electric element, an EESU power storage unit, an EESU charging interface, an external power interface, and an electrical energy generating source, according to an embodiment of the invention.

FIG. 2 shows a prior art EESU power storage unit with multiple capacitive elements, an Input/Output interface, and a common interface.

FIG. 3 shows a prior art apparatus with an electric element, a rechargeable battery, and a battery charge controller circuit.

FIG. 4 shows a prior art apparatus with an electric element, a rechargeable battery, a battery charge controller circuit, and an electrical energy generating source.

FIG. 5 shows a prior art apparatus with an electric element, a rechargeable battery, a battery charge controller circuit, an external power interface, and an electrical energy generating source.

FIG. 6 shows a prior art apparatus with an electric element, an EESU power storage unit, and an EESU charging interface.

FIG. 7 shows a prior art apparatus with an electric element, an EESU power storage unit, an EESU charging interface, and an electrical energy generating source.

FIG. 8 shows an apparatus with an electric element, an EESU power storage unit, an EESU charging interface, an external power interface, and multiple electrical energy generating sources, according to an embodiment of the invention.

FIG. 9 shows a prior art apparatus with a mechanical element, an internal combustion engine, and a fuel reservoir.

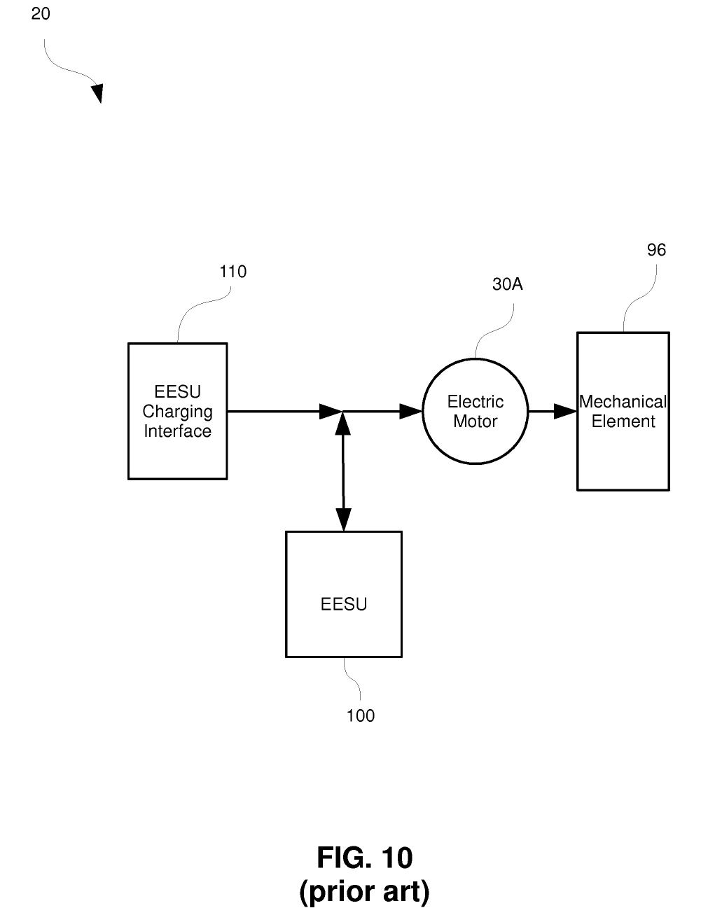

FIG. 10 shows a prior art apparatus with an electric motor as the electric element driving a mechanical element, an EESU power storage unit, and an EESU charging interface.

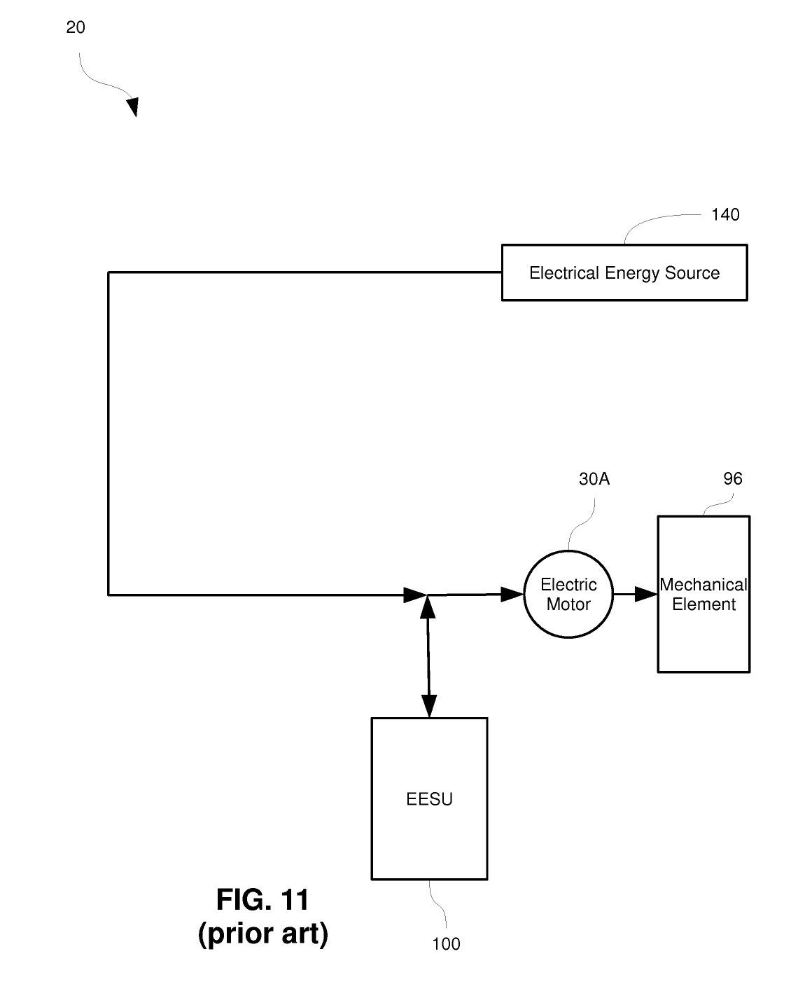

FIG. 11 shows a prior art apparatus with an electric motor as the electric element driving a mechanical element, an EESU power storage unit, an EESU charging interface, and an electrical energy generating source.

FIG. 12 shows an apparatus with an electric motor as the electric element driving a mechanical element, an EESU power storage unit, an EESU charging interface, an external power interface, and an electrical energy generating source, according to an embodiment of the invention.

FIG. 13 shows an apparatus with an electric motor as the electric element driving a mechanical element, an EESU power storage unit, an EESU charging interface, an external power interface, and multiple electrical energy generating sources, according to an embodiment of the invention.

FIG. 14 shows a prior art apparatus with a capacitor storage system and an external interface.

### REFERENCE NUMERALS

20 An Apparatus
30 Electric Element
30A Electric Motor as Electric Element
60 Rechargeable Battery
62 Battery Charge Controller
80 EESU Capacitive Element
82 EESU Common
84 EESU Input/Output
90 Internal Combustion Engine
92 Fuel Reservoir for Internal Combustion Engine
96 Mechanical Element
100 Electrical Energy Storage Unit (EESU) Power Storage Unit
102 Capacitor Storage System
110 EESU Charging Interface
114 External Power Interface
130 External Interface
140 Electrical Energy Generating Source

### DETAILED DESCRIPTION AND OPERATION

### FIG. 1—Preferred Embodiment

An embodiment of an apparatus of the present invention is illustrated in FIG. 1. An apparatus 20 includes an electrical energy storage unit (EESU) 100 to store and supply electrical energy within the apparatus, an EESU charging interface 110 to allow charging of the EESU 100, an electrical energy generating source 140 to provide electrical energy to charge the EESU 100, an external power interface 114 to provide power from an external power source to charge the EESU 100, and an electric element 30 such as a light, an electronic or electrical system, a motor-driven mechanical system, or some other electro-mechanical system to provide a useful output for the user. The EESU charging interface 110 can also be designed to supply power to the electric element 30 directly.

The EESU 100 is made up of multiple capacitive elements 80 connected together FIG. 2. As with most capacitors, there is a common reference interface 82, and an input/output interface 84.

The on-board EESU charging interface 110 within the apparatus of this embodiment of the invention is similar that of the EESU charging interface in a stand-alone EESU charger, not shown. An example of an EESU charging interface 110 is a complex integrated circuit capable of charge transfer to a capacitive device, with voltage regulation, and with discrete circuitry around it. Another example is a simple electrical, mechanical, or combination electrical and mechanical interface. Other variations are also valid.

An example of an electrical energy generating source 140 is a solar voltaic cell, or a group thereof, such as those used commonly in calculators, although any electrical energy generating source is appropriate for use in this invention.

Prior art apparatus that offer similar utility features to that of the current invention and that are based on a rechargeable battery are shown in FIGS. 3, 4, and 5. The prior art apparatus of FIG. 3 includes an electric element 30 as a useful output for the user, a rechargeable battery 60 to provide stored power to the electric element 30, and a built-in battery charge controller 62 to charge the rechargeable battery 60. The prior art apparatus of FIG. 4 is similar to the device of FIG. 3 but adds an on-board electrical energy generating source 140 to charge the rechargeable battery 60. Similar to the embodiment of FIG. 1, the prior art apparatus of FIG. 5 includes the features of FIGS. 3 and 4 and also includes an external power interface 114 to provide power from an external power source to charge the rechargeable battery 60 and possibly to power the electrical element 30 also.

Prior art apparatus that offer similar utility features to that of the current invention and that are based on an EESU and not a rechargeable battery are shown in FIGS. 6 and 7. The prior art apparatus of FIG. 6 includes an electric element 30 as a useful output for the user, an EESU 100 power storage unit to provide power to the electric element 30, and a built-in EESU charging interface 110 to charge the EESU. The prior art apparatus of FIG. 7 is similar to the device of FIG. 6 but adds an on-board electrical energy generating source 140 to charge the EESU 100.

### Operation—FIGS. 1, 2, 3, 4, 5, 6, 7, 8

Operational features of the FIG. 1 embodiment of the current invention are similar to those of prior art apparatus as shown in FIGS. 3, 4, 5, 6 and 7.

FIG. 5 shows a prior art system similar to the embodiment of FIG. 1 but with a rechargeable battery 60 for electrical power storage and as an energy source to power the electric element 30. Similar to devices of FIGS. 3 and 4, FIG. 5 includes a battery charge controller 62 that controls the charge process for the rechargeable battery 60, and an electrical energy generating source 140 capable of providing electrical energy to charge the battery 60. As an enhancement to FIGS. 3 and 4, an external power interface 114 to provide power from an external power source to charge the battery 60 is added.

The operation for this embodiment of this invention FIG. 1 is similar to that of the prior art apparatus 20 of FIG. 5. In normal operation electrical energy flows from the EESU 100 power storage to the electric element 30, and the electric element 30 operates in the manner for which it was designed. As energy is utilized to power the electric element 30, energy within the EESU 100 is depleted. The EESU 100 is recharged via the EESU charging interface 110 with electrical energy from either the external power interface 114 or the electrical energy generating source 140.

An exemplary apparatus 20 of the invention, FIG. 1, is a flashing school zone crosswalk light. The flashing light is the electrical element 30, the EESU 100 stores electrical power and provides emergency electrical power to the flashing light, a solar collector is utilized as the electrical energy generating source 140 to provide energy to charge the EESU 100, and an external power interface 114 is utilized to provide electrical power from the electric grid during normal operation. The EESU 100 is charged through the EESU charging interface 110 with electrical energy from either the solar collector 140, the electric grid via the external power interface 114, or both.

An exemplary EESU is a capacitive-based energy storage system based on the Electrical-Energy-Storage Unit (EESU) of Richard Dean Weir, U.S. Pat. No. 7,466,536 B1, or a capacitive ceramic-based system with similar qualities, designed appropriately for a flashing school zone crosswalk light.

An exemplary EESU charging circuit 110 is based on an LT3751 high voltage capacitor charger controller integrated circuit from Linear Technology. Along with appropriate periphery circuitry, examples of which are shown for specific configurations in the data sheet for the LT3751, the LT3751 capacitor charger controller may optionally require voltage regulation circuitry at its input to be powered from a solar collector, depending on the solar collector chosen for use. Also, along with appropriate periphery circuitry, the LT3751 capacitor charger controller may optionally require AC rectification and voltage regulation circuitry at its input to be powered from an external AC source such as the electric grid.

An exemplary solar collector can be made from XOB17-01x8 solar components from IXYS. A single unit gives a 4.90 Volt typical open circuit voltage output with a 4.2 miliamperes (mA) short circuit current. Utilizing multiple of these solar components in parallel or in series within an apparatus can give larger charge current capability, larger charge voltage capability, or both.

Under normal circumstances, during periods that the school zone speeds are in effect for the crosswalk, the flashing school zone crosswalk light operates from electricity received from the electric grid via the external power interface 114. During school zone operating periods when power from the electric grid is not available, power from the EESU 100 is utilized to allow the school zone crosswalk light to blink normally to indicate that school zone speeds are in effect. As energy is utilized to power the blinking school zone light 30, energy within the EESU 100 is depleted. To charge the EESU 100, power flows from the solar collector 140 through the EESU charge controller 110 to the EESU.

FIG. 8 is a similar embodiment to that illustrated in FIG. 1 but utilizes multiple on-board electrical energy generating sources 140 for electrical energy generation. The FIG. 1 exemplary apparatus described above includes a flashing school zone crosswalk light with a solar collector to provide backup power to charge the EESU 100 power storage unit. Adding a second electrical energy generator 140 such as a small wind-powered generator gives backup energy not only when the sun in shining, but also anytime the wind is blowing, even in the dark early morning when sunlight is not yet available to the solar collector for electrical energy generation in the device.

### FIGS. 9, 10, 11, 12 and 13—Additional Embodiment

FIGS. 11, 12 and 13 show additional embodiments of the current invention. The apparatus 20 of FIG. 11 includes a mechanical element 96 to provide a useful output for the user, an electric motor 30A as the electric element to provide motion for the mechanical element, an EESU 100 for power storage and supply within the apparatus, and an electrical energy source 140 to provide energy to charge the EESU 100. The apparatus 20 of FIG. 12 includes an external power interface 114 to provide power from an external power interface and an EESU charging interface 110 to charge the EESU 100 from either the external power interface 114 or the electrical energy source 140. The apparatus 20 of FIG. 13 includes multiple electrical energy generating sources 140 as well as an external power interface 114 to provide energy to charge the EESU 100 and possibly to power the electric motor 30A directly.

This embodiment is similar to prior art illustrated in FIGS. 10 and 11. Where FIG. 10 has an EESU charging interface 110 and no specified energy inputs, and FIG. 11 has an input from an electrical energy generating source 140, the apparatus of the current invention allows electrical energy input from both an external power interface 114 as well as from an electrical energy generating source 140.

### Operation—FIGS. 9, 10, 11, 12 and 13

The operation for the apparatus 20 of this embodiment of the invention FIG. 12 is such that the electric motor 30A operates as the electric element of the invention and drives the mechanical element 96. The EESU supplies electrical energy to power the electric motor 30A. As energy is utilized to power the electric motor 30A, energy within the EESU 100 is depleted. The EESU 100 is charged by passing energy through the EESU charging interface 110 to the EESU 100 from either the external power interface 114 or the electrical energy generating source 140.

An exemplary apparatus 20 of this embodiment of the invention, FIG. 12, is a vehicle with an electric motor/controller combination as the electric element 30, either driving a transmission or directly driving a wheel as the mechanical element 96, with a solar collector as an electrical energy generating source 140 to charge the EESU 100 when in sunlight, and with an external power interface 140 to allow connection to a power source such as a 110 Volt or 220 Volt wall outlet to charge the vehicle when parked.

The common prior art vehicle FIG. 9 utilizes a gasoline engine 90 to drive a mechanical element 96, either a transmission or a wheel, directly. The energy for the gasoline engine 90 is stored in the vehicles' gasoline storage tank 92. To recharge the gasoline powered vehicle, a user refills the gasoline storage tank 92. Built-in energy sources, such as electrical energy generating source 140, are not common on most prior art gasoline power vehicles.

An exemplary electric motor/controller combination is GE part number M9164 for the motor and Yaskawa part number P7U20370 for the motor controller.

An exemplary EESU 100 is the Electrical-Energy-Storage Unit (EESU) of Richard Dean Weir, U.S. Pat. No. 7,466,536 B1, or a capacitive ceramic-based system with similar qualities, designed appropriately for a vehicle.

An exemplary EESU charging circuit 110 includes a circuit based on the LT3751 high voltage capacitor charger controller integrated circuit from Linear Technology.

An exemplary solar collector can be made from XOB17-01x8 solar components from IXYS. Utilizing multiple of these solar components within the vehicle can give multiple watts of power to recharge the EESU 100 during much of the day.

A vehicle of this embodiment FIG. 12 utilizes the GE M9164 motor and Yaskawa P7U20370 motor controller combination 30A to drive the mechanical element, the wheel or the transmission 96. The EESU supplies electrical energy to power the motor/controller 30A. As energy is utilized to power the motor/controller 30A, energy within the EESU 100 is depleted. The LT3751 high voltage capacitor charger controller 110 recharges the EESU 100 with energy from the IXYS XOB17-01-8 solar components that make up the electrical energy generating source 140. The solar collector can recharge the EESU whenever sunlight is available, either while in operation or while parked. When the vehicle of this exemplary embodiment is parked, the external power interface 114 can be connected to an electrical wall outlet and the EESU charging interface 110 can charge the EESU 100 using power from the wall outlet. While this exemplary apparatus is not optimized, it shows the basic concepts involved in this invention.

FIG. 13 is a similar embodiment to that illustrated in FIG. 12 but utilizes multiple on-board electrical energy generating sources 140. Utilizing multiple on-board electrical energy generation sources simultaneously allows even more energy to be generated from renewable sources. This gives the potential to harvest all available electrical energy. Adding to the exemplary apparatus 20 of FIG. 12, energy regeneration from braking could be utilized to charge the EESU 100 along with solar collector energy to give even higher energy efficiencies for the vehicle. Other on-board energy generation sources could also be added in this embodiment including energy generation from wind-power, acoustic power, water-power, man-power, combustion engine power, and others.

### CONCLUSION, RAMIFICATIONS, AND SCOPE

Thus the reader can see that many useful, reliable, and convenient devices can be created for users utilizing the elements of this invention, devices with unique features and operational capabilities that are distinct from prior art devices based on electro-chemical batteries, internal combustion engines, or ultracapacitors.

Improvements over prior art devices include greatly enhanced reliability due to nearly unlimited recharge capability, the ability to recharge from nearly anywhere on the current electric grid, ruggedness over temperature and voltage variations, and enhanced long-term energy storage capabilities and shelf life due to the extremely low self-discharge properties of the EESU power storage unit within the apparatus. A device of this invention has minimal impact on the environment as compared to prior art devices since recharging devices of this invention affords long lasting convenience to the user while requiring little need for the user to change out or to discard an EESU power storage unit within the apparatus as with prior art batteries in battery based devices, thus eliminating much waste and pollution from being added to the environment. Also, when comparing an apparatus of this invention with an apparatus based on an internal combustion engine, a user can expect lower pollution, less mess, and a lower overall energy usage footprint for the environment. The capability of a device of this invention to be compact due to the EESU having a higher energy density than batteries or ultracapacitors can make many devices portable and convenient, and can therefore make them more useful to users than is possible with prior art devices, especially devices based on prior art capacitors.

Thus the combination of better overall reliability and durability, the ability to recharge quickly nearly anywhere by connecting to the current electric grid, on-board recharging capability utilizing nearly any electrical energy generation source, reduced noise as compared to an internal combustion engine, smaller size, better portability, reduced waste, reduced pollution, and better user convenience are the features that make a device of this invention unique as compared to prior art devices.

While the above description contains many specificities, these should not be construed as limitations on the scope of the invention, but rather as exemplifications of preferred embodiments thereof. Many other variations are possible. For example, the EESU need not be limited to the EESU of Richard Dean Weir, U.S. Pat. No. 7,466,536 B1. Other capacitive, ceramic-based electrical energy storage units utilizing ceramic sintered with other substances of high permittivity may also be utilized. Of course various storage capacities, various unit sizes, and various operating voltages may also be utilized.

The on-board EESU charging interface can consist of any interface capable of charging the EESU, not just electronic circuitry based on the LT3751 high voltage capacitor charger controller integrated circuit as exemplified above.

The on-board electrical energy source is not limited to a solar collector based on the XOB17-01x8 solar components from IXYS. Any solar components, or group of solar components, will fulfill the requirements of this element of this invention. Also, energy generation on devices of this invention is not limited to solar devices, but can come from any electrical energy generation source including solar, wind, acoustic, static, electro-mechanical including electric motor feedback, man-powered, thermal, water-powered, as well as an electric generator powered by an internal combustion engine, and others.

An electric element can consist of not just a light, an electronic or electrical component or circuit, a motor-driven mechanical system, or some other electro-mechanical system, but of any electric element capable of being driven by an electrical energy source in an apparatus.

An electric motor acting as an electric element can drive nearly any mechanical device including a wheel, a drive shaft, a geared device such as a transmission, gardening implements or any other mechanical device.

Thus the scope of the invention should be determined by the appended claims and their legal equivalents, rather than by the examples given.

I claim:

1. An apparatus, comprising:
an electrical-energy-using element (electric element),
a capacitive ceramic-based electrical energy storage unit (EESU),
an interface capable of charging said EESU,
an electrical energy source, and
an external power interface,
wherein said EESU is capable of operating as a power source for said electric element, and said EESU is capable of being charged by said interface capable of charging said EESU with electrical energy from said electrical energy source and said external power interface.

2. The EESU of claim 1 wherein components of said EESU are manufactured with the use of ceramic fabrication techniques.

3. The EESU of claim 1 wherein said components of said EESU are manufactured using barium titanate.

4. The electric element of claim 1 wherein said element includes a light.

5. The electric element of claim 1 wherein said element includes an electrical component.

6. The electric element of claim 1 wherein said element includes an electronic circuit.

7. The electric element of claim 1 wherein said element includes an electric motor.

8. The interface for charging said EESU of claim 1 wherein said interface includes voltage conversion circuitry.

9. The interface for charging said EESU of claim 1 wherein said interface includes charge control circuitry.

10. The electrical energy source of claim 1 wherein said electrical energy source includes solar electrical energy generation.

11. The electrical energy source of claim 1 wherein said electrical energy source includes wind electrical energy generation.

12. The electrical energy source of claim 1 wherein said electrical energy source includes electro-mechanical electrical energy generation including electric motor feedback.

13. The electrical energy source of claim 1 wherein said electrical energy source includes man-powered electrical energy generation.

14. The electrical energy source of claim 1 wherein said electrical energy source includes electrical energy generation including an internal combustion engine.

15. The electrical energy source of claim 1 wherein said electrical energy source includes water-powered or rain-powered electrical energy generation.

16. An apparatus, comprising:
a means for using electrical energy,
a capacitive ceramic-based electrical energy storage unit (EESU),
an interface capable of charging said EESU,
a means for generating electrical energy, and
an external power interface,
wherein said EESU is coupled to said means for using electrical energy, said interface capable of charging said EESU, said means for generating electrical energy, and said external power interface.

17. In an apparatus, a method of generating, storing, and supplying electrical energy comprising:
supplying electrical energy to an electrical-energy-using element (electric element) from a capacitive ceramic-based electrical energy storage unit (EESU),
generating electrical energy in an electrical energy source,
storing electrical energy from said electrical energy source and an external interface into said EESU with an interface capable of charging said EESU.

18. The EESU of claim 17 wherein components of said EESU are manufactured with the use of ceramic fabrication techniques.

19. The electric element of claim 17 wherein said electric element includes an electrical component.

20. The electrical energy source of claim 17 wherein said electrical energy source includes solar electrical energy generation.
